(19) United States
(12) Patent Application Publication
(10) Pub. No.: US 2025/0181466 A1
(43) Pub. Date: Jun. 5, 2025

(54) Hardware Test Mode for Processor Core

(71) Applicant: SiFive, Inc., San Mateo, CA (US)

(72) Inventors: Monia Chiavacci, San Marcello Piteglio (IT); Robin Randhawa, Cambridge (GB); Trefor Southwell, Bristol (GB)

(21) Appl. No.: 18/529,694

(22) Filed: Dec. 5, 2023

(51) Int. Cl. G06F 11/263

(52) U.S. Cl. CPC G06F 11/263

(57) ABSTRACT

Systems and methods are disclosed for implementing a hardware test mode for a processor core. For example, some methods may include writing to one or more test mode registers to change a microarchitectural state of a processor core from a first state to one or more test mode states; executing a sequence of instructions on the processor core in the one or more test mode states to obtain a resulting architectural state of the processor core; comparing the resulting architectural state to an expected architectural state associated with the sequence of instructions to obtain a test result; and writing to the one or more test mode registers to restore the microarchitectural state of the processor core to the first state.

### TECHNICAL FIELD

This disclosure relates to a hardware test mode for a processor core.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an integrated circuit implementing a hardware test mode for a processor core.

FIG. 2 is a block diagram of an example of an integrated circuit implementing a hardware test mode for a processor core with an external hardware test controller.

FIG. 3 is a flowchart of an example of a process for implementing a hardware test mode for a processor core.

FIG. 4 is a flowchart of an example of a process for handling an interrupt during a test executed in a hardware test mode.

FIG. 5 is a block diagram of an example of a system for generating test result data based on data resulting from the execution of a sequence of instructions in a hardware test mode.

FIG. 6 is a block diagram of an example of software for utilizing a hardware test mode for a processor core.

FIG. 7 is a block diagram of an example of a system for facilitating generation and manufacture of integrated circuits.

FIG. 8 is a block diagram of an example of a system for facilitating generation of integrated circuits.

### DETAILED DESCRIPTION

Disclosed herein are implementations of a hardware test mode for a processor core. The hardware test mode may be invoked periodically (e.g., every second, every 100 milliseconds, every 10 milliseconds, or every millisecond) for testing of a processor core to check for hardware faults (e.g., stuck-at fault or delay fault). For example, if a fault is detected, the execution of user mode application software threads may be reallocated to other processor cores of a system on a chip (SOC); the system could go into a safe mode; the system could shutdown particular features; and/or the system could report the fault. One or more test mode registers of the processor core may provide an interface for software or an external hardware agent to control changes to a microarchitectural state of the processor core to facilitate rapid testing of components of the processor core with broad coverage of the available components. For example, a test mode configurable through the one or more test mode registers may force one of multiple processor pipelines in the processor core to be selected in a dispatch stage for execution of test instructions. In some implementations one or more processor pipelines are temporarily disabled to force test instructions to executed using a different pipeline. In some implementations, a test mode configuration may force a rename stage of the processor core to assign physical registers of a physical register file in a fixed order to ensure full coverage of all physical registers during a hardware test of the processor core. For example, the one or more test mode registers may be memory mapped and/or accessible using control status register (CSR) instructions of an instruction set architecture. A sequence of instructions (e.g., hardware test software) executed in the one or more test modes controlled with the one or more test mode registers may result in changes to an architectural state of the processor core and/or other intermediate results, which can be compared to expected results associated with the sequence of instructions to detect hardware fault conditions. In some implementations, a hash function (e.g., based on XOR) is used to compress result data for comparison and/or export from the processor core. The test modes controlled using the one or more test mode registers may be interruptible to increase availability of the processor core for user applications during in-field testing using the test modes.

Some implementations are intended to keep the hardware modifications to a minimum. The hardware changes may improve 1. controllability—the ability of software to repeatably stimulate a hardware fault so that it generates an effect and achieve a given coverage metric of the hardware; and 2. observability—the ability of software to observe the effects of hardware faults and report them. For example, a hardware test may be implemented with software run on a processor core which intends to achieve a target level of fault coverage (e.g., 75%) for the processor core. In some implementations, a hardware test is implemented with software running on a processor core that intends to control and then observe a certain amount of faults. That number, divided by the overall number of faults potentially affecting the processor core is the so called permanent fault coverage (e.g., 75%).

### Test Mode Behavior:

In test mode, branch prediction may be put into a basic mode where it always predicts branches as taken. The call/return stack and any absolute jump prediction may be disabled. As code is fetched from the instruction cache, it is liable to cache misses as well as hits. This could lead to a problem where stimulus doesn't provide the coverage needed in the event of cache misses creating bubbles in the pipeline. In some implementations, the test kernel may be pre-fetched to avoid misses during it's running. In some implementations, the tests may be designed to tolerate stalls. In some implementations, instructions in the same cache line may be executed without stalls. The allocation of instructions to pipelines may be put into a deterministic mode (not demand driven). For example, this could be a basic round-robin or a similar scheme. In some implementations, the allocation mode may be the same every time the same code is run, regardless of previous state or stalls. The allocation of physical registers may be put into a deterministic mode where the order of allocation does not depend on any stalls/dynamics.

In some implementations, a test memory device is included in an integrated circuit (e.g., an SOC). The test memory device is positioned on an interconnect, logically before a shared cache (e.g., an L2 cache). For example, the test memory device may have a fixed 1 Mb address region in the memory map, which will only be accessible in m-mode (due to the memory map configuration and not due to hardware limits). The test memory device may contain 16×64 bit pattern registers—PATTERN[x]. PATTERN[n] may be reset to 0xaaaaaaaa. Writes to any address within the 1 Mb address region will write to PATTERN[address[6:3]]. Reads to any address within the 1 Mb address region may return the XOR of the pattern and the address: PATTERN[address[6:3]]\hat{ }{address[63:7], 7′b0}]. The test memory device can be used by the test software to exercise the read/write path of the processor core without having to access a shared cache or external memory.

As used herein, the term “circuitry” refers to an arrangement of electronic components (e.g., transistors, resistors, capacitors, and/or inductors) that is structured to implement one or more functions. For example, a circuitry may include one or more transistors interconnected to form logic gates that collectively implement a logical function.

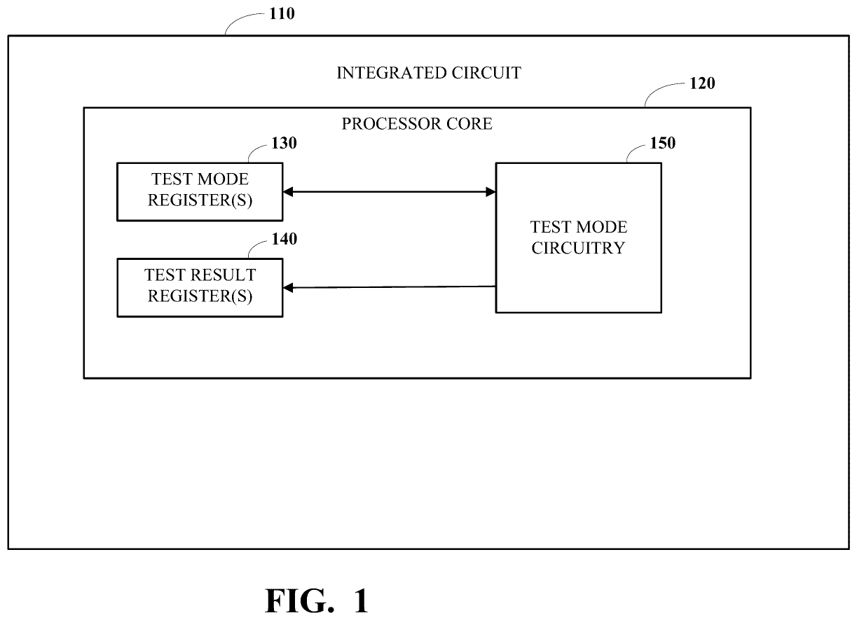

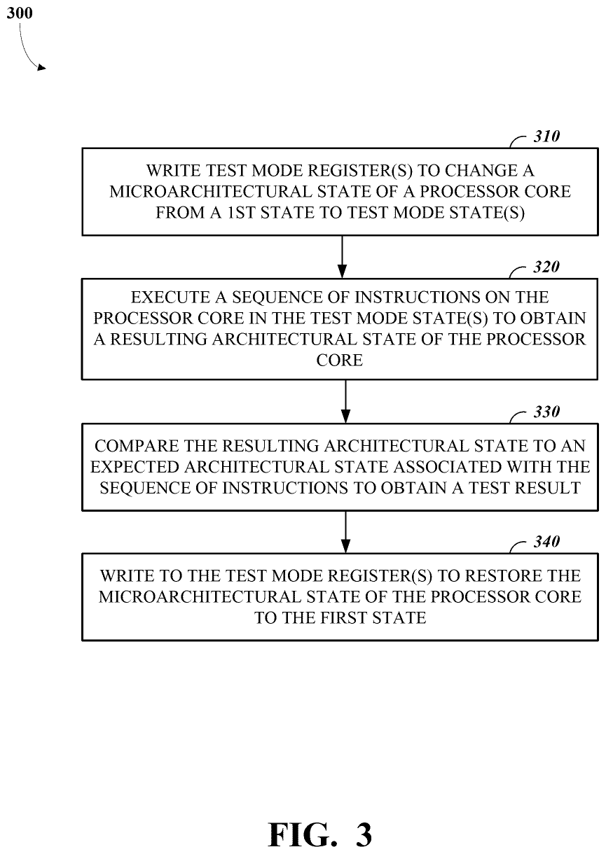

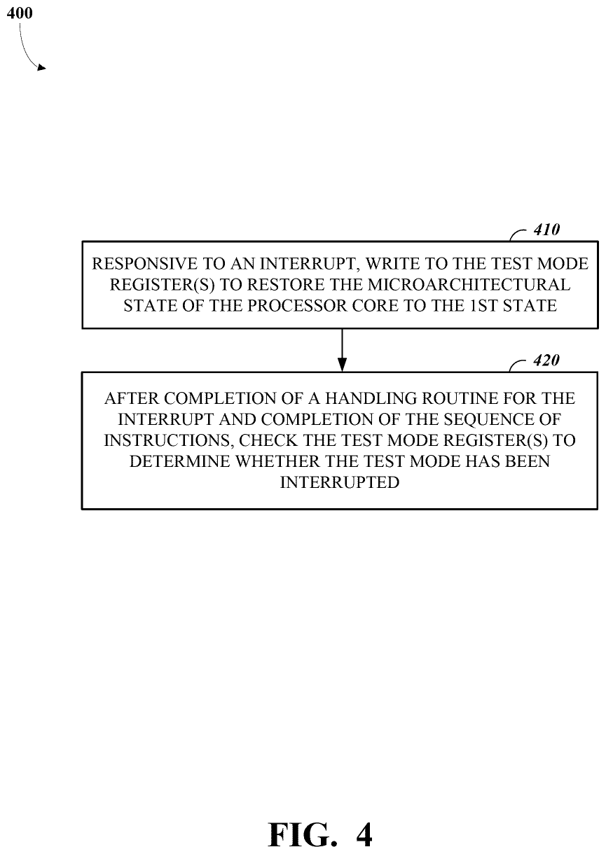

FIG. 1 is a block diagram of an example of an integrated circuit 110 implementing a hardware test mode for a processor core. The integrated circuit 110 includes a processor core 120 configured to execute instructions; one or more test mode registers 130 configured to store test mode selection data; one or more test result registers 140 configured to store test result data; and a test mode circuitry 150 configured to control a microarchitectural state of the processor core 120 based on the test mode selection data stored in the one or more test mode registers 130. The one or more test mode registers 130 may provide an interface for controlling the microarchitectural state of the processor core 120 to facilitate efficient hardware testing of various components of the processor core 120 during a field deployment (e.g., performed outside of a lab setting, without special test equipment, and in conjunction with execution of user applications running on the processor core 120) of the integrated circuit 110. For example, the integrated circuit 110 may be used to implement the technique 300 of FIG. 3. For example, the integrated circuit 110 may be used to implement the technique 400 of FIG. 4.

The integrated circuit 110 includes a processor core 120 configured to execute instructions. The processor core 120 may include a one or more execution resource circuitries configured to execute micro-ops to support an instruction set architecture including macro-ops. The processor core 120 may be configured to fetch macro-ops from a memory system of the integrated circuit 110 in a program order. For example, the instruction set architecture may be a RISC-V instruction set architecture. For example, the one or more execution resource circuitries may include an adder, a shift register, a multiplier, a floating-point unit a vector adder, a vector multiply accumulate unit, and/or a load/store unit. The one or more execution resource circuitries may update an architectural state of the processor core 120, including internal registers and/or flags or status bits based on results of executing a micro-op. Results of execution of a micro-op may also be written to the memory system. In some implementations, the execution resource circuitries of the processor core 120 are components of multiple processor pipelines in an execution stage of the processor core 120 to which instructions are dispatched by a dispatch stage of the processor core 120. The processor core 120 may include other stages, such as one or more fetch stages, a decode stage, a rename stage, and/or a writeback stage. In some implementations, the processor core 120 is an out-of-order processor that may include a reorder buffer. The flow of an instruction (or one or more micro-ops implementing the instruction) through the various stages of the processor core 120, such as which of multiple processor pipelines the instruction is dispatched to, may be affected or controlled by a microarchitectural state of the processor core 120, which is not defined by the instruction set architecture and is not directly accessible by user mode software running on the processor core 120.

The integrated circuit 110 includes one or more test mode registers 130 configured to store test mode selection data. For example, the test mode selection data includes a bit that enables a hardware test mode that is used to execute a sequence of instructions associated with expected results to perform a test of the hardware of the processor core 120 to check that the components of the processor core are still functioning as expected. Enabling the hardware test mode may cause a micro architectural state of the processor core 120 to be altered in a way that facilitates hardware testing of the processor core 120. The one or more test mode registers 130 may provide an interface for dynamically enabling and disabling the hardware test mode to perform hardware testing intermittently during field deployment of the integrated circuit, while the processor core 120 is being used to execute user application software. For example, this field testing of the hardware of the processor core 120 may be performed periodically and it may provide greater reliability for running software on the integrated circuit 110, which may include multiple additional processor cores (not shown in FIG. 1) for executing user application software. In some implementations, test mode selection data includes multiple bits that enable fine-grained control of a microarchitectural state of the processor core 120 to facilitate fast testing with broad or complete coverage of many components of the processor core 120. In some implementations, the one or more test mode registers 130 may include a control status register of the processor core 120. For example, the one or more test mode registers 130 may be written to using a control status register instruction of an instruction set architecture supported by the processor core 120. In some implementations, the one or more test mode registers 130 are memory mapped and are written to using a store instruction of an instruction set architecture supported by the processor core 120.

The integrated circuit 110 includes one or more test result registers 140 configured to store test result data. The one or more test result registers 140 may provide an interface for efficiently exporting test result data from the processor core 120. In some implementations, the one or more test result registers 140 may provide greater observability of faults and changes in microarchitectural state occurring in the processor core 120 during hardware testing the hardware test mode. In some implementations, the one or more test result registers 140 may include a control status register of the processor core 120. For example, the one or more test result registers 140 may be read using a control status register instruction of an instruction set architecture supported by the processor core 120. In some implementations, the one or more test result registers 140 are memory mapped and are read using a load instruction of an instruction set architecture supported by the processor core 120.

The integrated circuit 110 includes a test mode circuitry 150. The test mode circuitry 150 is configured to change a microarchitectural state of the processor core 120 from a first state (e.g., a standard state microarchitectural state used to execute user mode application software) to one or more test mode states based on test mode selection data written to the one or more test mode registers 130; execute a sequence of instructions (e.g., a sequence of instructions constituting a hardware test) on the processor core 120 in the one or more test mode states to obtain a resulting architectural state of the processor core 120; store test result data based on the resulting architectural state in the one or more test result registers 140; and, after executing the sequence of instructions, restore the microarchitectural state of the processor core 120 to the first state based on test mode selection data written to the one or more test mode registers 130. The test mode circuitry 150 may dynamically switch the processor core 120 into and back out of a hardware test mode that is used to run the sequence of instructions used to test components of the processor core 120. Dynamically switching the processor core 120 into and back out of a hardware test mode may enable in-field hardware testing of the processor core 120 while the integrated circuit 110 is being used to execute user mode application software. By changing the microarchitectural state of the processor core 120 based on the test mode selection data, a high degree of controllability and/or observability may be achieved that enables quick, reliable, and repeatable testing with broad component coverage of the processor core 120 running the sequence of instructions. In some implementations, at least one of the one or more test mode states forces a processor pipeline branch of the processor core 120 to be selected in a dispatch stage of the processor core 120. In some implementations, at least one of the one or more test mode states causes a processor pipeline branch (e.g., one of multiple scalar execution pipeline branches or one of multiple vector execution pipeline branches) of the processor core to be disabled. In some implementations, at least one of the one or more test mode states forces a rename stage of the processor core to allocate physical registers of the processor core in a fixed order. Forcing the allocation of physical registers in a fixed order may provide the controllability to achieve complete coverage of a physical register file of the processor core 120 using the sequence of instructions. In some implementations, at least one of the one or more test mode states forces each of multiple processor pipelines of the processor core to be selected in fixed order by a dispatch stage of the processor core.

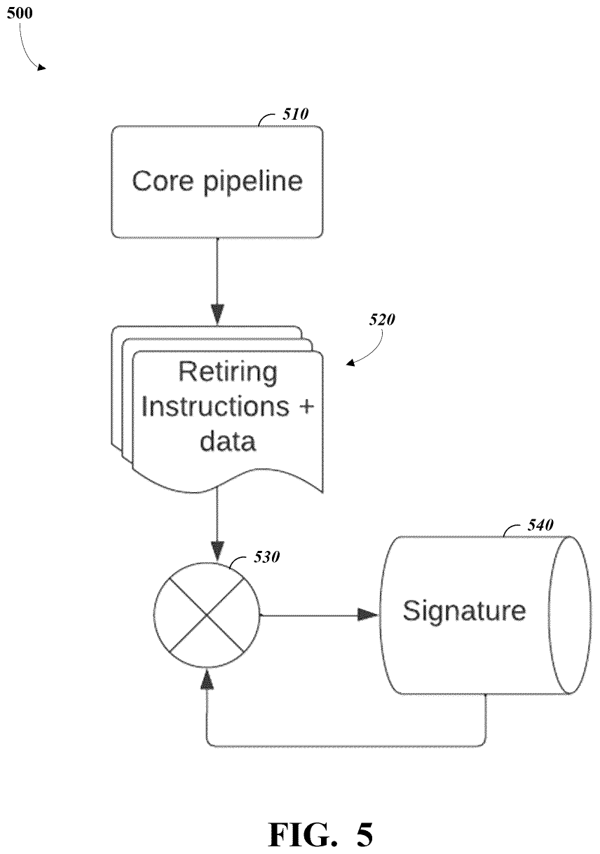

The test result data exported via the one or more test result registers 140 may provide an efficient summary (e.g., a hash) of a variety of final and/or intermediate results of executing the sequence of instructions on the processor core 120 in the hardware test mode. For example, the test result data may include an XOR (exclusive or) of data, including the resulting architectural state, generated when executing the sequence of instructions. In some implementations, the test result data may be based on intermediate results generated when executing an instruction of the sequence of instructions before the instruction is retired. In some implementations, the test result data may include an XOR of data, including opcodes for retired instructions, generated when executing the sequence of instructions. For example, the system 500 of FIG. 5 may be used to generate the test result data stored in the one or more test result registers 140.

The hardware test mode may be interruptible to enable higher availability of the processor core 120 for user mode application software during a field deployment where the hardware test mode is being used. To facilitate hardware testing in the presence of interrupts, it may be helpful to detect when the running of a hardware test in the hardware test mode has been interrupted. In some implementations, the test mode circuitry 150 is configured to, responsive to an interrupt, write to the one or more test mode registers 130 to restore the microarchitectural state of the processor core 120 to the first state; and, after completion of a handling routine for the interrupt and completion of execution of the sequence of instructions, check the one or more test mode registers 130 to determine whether the test mode has been interrupted. For example, a hardware enable bit in one or more test mode registers 130 may be left in a disabled state after taking an interrupt during testing and the results of the current test may be discarded and/or reported as part of an aborted test. In some implementations, one or more addition bits stored in the one or more test mode registers 130 may be used to notate separately from a test mode enable bit that a current test has been interrupted.

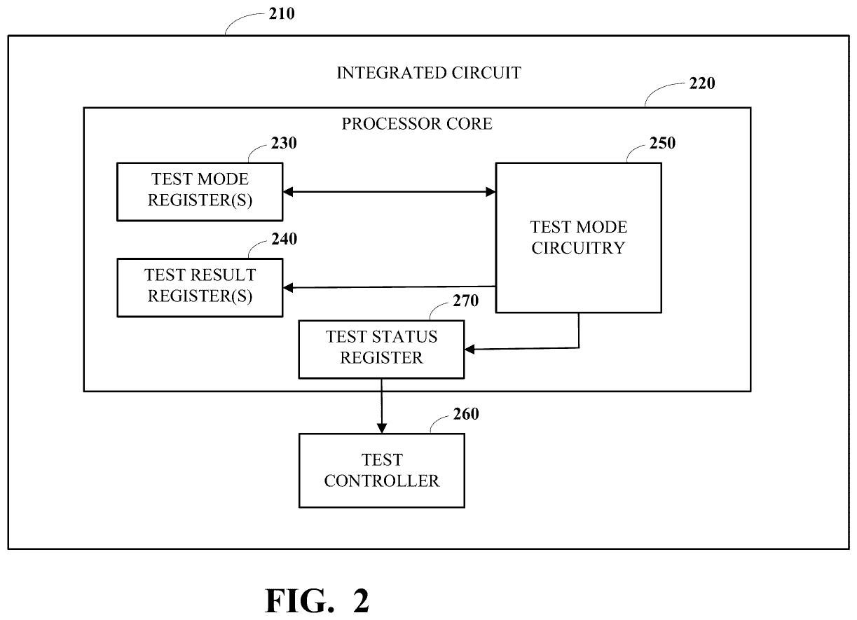

FIG. 2 is a block diagram of an example of an integrated circuit 210 implementing a hardware test mode for a processor core with an external hardware test controller. The integrated circuit 210 includes a processor core 220 configured to execute instructions; one or more test mode registers 230 configured to store test mode selection data; one or more test result registers 240 configured to store test result data; a test mode circuitry 250 configured to control a microarchitectural state of the processor core 220 based on the test mode selection data stored in the one or more test mode registers 230; a test controller 260 configured to periodically initiate testing of the processor core 220; and a test status register 270 accessible by the test controller 260. The one or more test mode registers 230 may provide an interface for controlling the microarchitectural state of the processor core 220 to facilitate efficient hardware testing of various components of the processor core 220 during a field deployment (e.g., performed outside of a lab setting, without special test equipment, and in conjunction with execution of user applications running on the processor core 220) of the integrated circuit 210. The test status register 270 may provide an interface for monitoring the status of a current hardware test being run in a hardware test mode on the processor core 220. For example, the integrated circuit 210 may be used to implement the technique 300 of FIG. 3. For example, the integrated circuit 210 may be used to implement the technique 400 of FIG. 4.

The integrated circuit 210 includes a processor core 220 configured to execute instructions. The processor core 220 may include a one or more execution resource circuitries configured to execute micro-ops to support an instruction set architecture including macro-ops. The processor core 220 may be configured to fetch macro-ops from a memory system of the integrated circuit 210 in a program order. For example, the instruction set architecture may be a RISC-V instruction set architecture. For example, the one or more execution resource circuitries may include an adder, a shift register, a multiplier, a floating-point unit a vector adder, a vector multiply accumulate unit, and/or a load/store unit. The one or more execution resource circuitries may update an architectural state of the processor core 220, including internal registers and/or flags or status bits based on results of executing a micro-op. Results of execution of a micro-op may also be written to the memory system. In some implementations, the execution resource circuitries of the processor core 220 are components of multiple processor pipelines in an execution stage of the processor core 220 to which instructions are dispatched by a dispatch stage of the processor core 220. The processor core 220 may include other stages, such as one or more fetch stages, a decode stage, a rename stage, and/or a writeback stage. In some implementations, the processor core 220 is an out-of-order processor that may include a reorder buffer. The flow of an instruction (or one or more micro-ops implementing the instruction) through the various stages of the processor core 220, such as which of multiple processor pipelines the instruction is dispatched to, may be affected or controlled by a microarchitectural state of the processor core 220, which is not defined by the instruction set architecture and is not directly accessible by user mode software running on the processor core 220.

The integrated circuit 210 includes one or more test mode registers 230 configured to store test mode selection data. For example, the test mode selection data includes a bit that enables a hardware test mode that is used to execute a sequence of instructions associated with expected results to perform a test of the hardware of the processor core 220 to check that the components of the processor core are still functioning as expected. Enabling the hardware test mode may cause a micro architectural state of the processor core 220 to be altered in a way that facilitates hardware testing of the processor core 220. The one or more test mode registers 230 may provide an interface for dynamically enabling and disabling the hardware test mode to perform hardware testing intermittently during field deployment of the integrated circuit, while the processor core 220 is being used to execute user application software. For example, this field testing of the hardware of the processor core 220 may be performed periodically and it may provide greater reliability for running software on the integrated circuit 210, which may include multiple additional processor cores (not shown in FIG. 2) for executing user application software. In some implementations, test mode selection data includes multiple bits that enable fine-grained control of a microarchitectural state of the processor core 220 to facilitate fast testing with broad or complete coverage of many components of the processor core 220. In some implementations, the one or more test mode registers 230 may include a control status register of the processor core 220. For example, the one or more test mode registers 230 may be written to using a control status register instruction of an instruction set architecture supported by the processor core 220. In some implementations, the one or more test mode registers 230 are memory mapped and are written to using a store instruction of an instruction set architecture supported by the processor core 220.

The integrated circuit 210 includes one or more test result registers 240 configured to store test result data. The one or more test result registers 240 may provide an interface for efficiently exporting test result data from the processor core 220. In some implementations, the one or more test result registers 240 may provide greater observability of faults and changes in microarchitectural state occurring in the processor core 220 during hardware testing the hardware test mode. In some implementations, the one or more test result registers 240 may include a control status register of the processor core 220. For example, the one or more test result registers 240 may be read using a control status register instruction of an instruction set architecture supported by the processor core 220. In some implementations, the one or more test result registers 240 are memory mapped and are read using a load instruction of an instruction set architecture supported by the processor core 220.

The integrated circuit 210 includes a test mode circuitry 250. The test mode circuitry 250 is configured to change a microarchitectural state of the processor core 220 from a first state (e.g., a standard state microarchitectural state used to execute user mode application software) to one or more test mode states based on test mode selection data written to the one or more test mode registers 230; execute a sequence of instructions (e.g., a sequence of instructions constituting a hardware test) on the processor core 220 in the one or more test mode states to obtain a resulting architectural state of the processor core 220; store test result data based on the resulting architectural state in the one or more test result registers 240; and, after executing the sequence of instructions, restore the microarchitectural state of the processor core 220 to the first state based on test mode selection data written to the one or more test mode registers 230. The test mode circuitry 250 may dynamically switch the processor core 220 into and back out of a hardware test mode that is used to run the sequence of instructions used to test components of the processor core 220. Dynamically switching the processor core 220 into and back out of a hardware test mode may enable in-field hardware testing of the processor core 220 while the integrated circuit 210 is being used to execute user mode application software. By changing the microarchitectural state of the processor core 220 based on the test mode selection data, a high degree of controllability may be achieved that enables quick, reliable, and repeatable testing with broad component coverage of the processor core 220 running the sequence of instructions. In some implementations, at least one of the one or more test mode states forces a processor pipeline branch of the processor core 220 to be selected in a dispatch stage of the processor core 220. In some implementations, at least one of the one or more test mode states causes a processor pipeline branch of the processor core to be disabled. In some implementations, at least one of the one or more test mode states forces a rename stage of the processor core to allocate physical registers of the processor core in a fixed order. Forcing the allocation of physical registers in a fixed order may provide the controllability to achieve complete coverage of a physical register file of the processor core 220 using the sequence of instructions. In some implementations, at least one of the one or more test mode states forces each of multiple processor pipelines of the processor core to be selected in fixed order by a dispatch stage of the processor core.

The test result data exported via the one or more test result registers 240 may provide an efficient summary (e.g., a hash) of a variety of final and/or intermediate results of executing the sequence of instructions on the processor core 220 in the hardware test mode. For example, the test result data may include an XOR (exclusive or) of data, including the resulting architectural state, generated when executing the sequence of instructions. In some implementations, the test result data may be based on intermediate results generated when executing an instruction of the sequence of instructions before the instruction is retired. In some implementations, the test result data may include an XOR of data, including opcodes for retired instructions, generated when executing the sequence of instructions. For example, the system 500 of FIG. 5 may be used to generate the test result data stored in the one or more test result registers 240.

The hardware test mode may be interruptible to enable higher availability of the processor core 220 for user mode application software during a field deployment where the hardware test mode is being used. To facilitate hardware testing in the presence of interrupts, it may be helpful to detect when the running of a hardware test in the hardware test mode has been interrupted. In some implementations, the test mode circuitry 250 is configured to, responsive to an interrupt, write to the one or more test mode registers 230 to restore the microarchitectural state of the processor core 220 to the first state; and, after completion of a handling routine for the interrupt and completion of execution of the sequence of instructions, check the one or more test mode registers 230 to determine whether the test mode has been interrupted. For example, a hardware enable bit in one or more test mode registers 230 may be left in a disabled state after taking an interrupt during testing and the results of the current test may be discarded and/or reported as part of an aborted test. In some implementations, one or more addition bits stored in the one or more test mode registers 230 may be used to notate separately from a test mode enable bit that a current test has been interrupted.

The integrated circuit 210 includes a test controller 260, external to the processor core 220, configured to periodically initiate testing of the processor core 220 by writing to the one or more test mode registers 230. In some implementations, the test controller 260 includes another processor core of the integrated circuit 210. The processor core 220 includes a test status register 270 accessible by the test controller 260. The test status register 270 may be configured to store an indication of test status that indicates whether a test is running, interrupted, or completed. The test status register 270 may be updated by the test mode circuitry 250. The test status register 270 may provide an interface that facilitates the control of hardware testing of the processor core 220 in a hardware test mode. The test mode circuitry 250 may be configured to write a test identifier to the test status register 270; and write an indication of test status to the test status register 270, wherein the indication of test status indicates whether a test is running, interrupted, or completed. The test status register 270 may be used to communicate the test status directly to the external test controller 260. In some implementations, the test status register 270 is only accessible in a machine mode (m-mode). For example, the test status register 270 may store a Test-ID field (16-bit) and a test status field (3 bits), where the test status field will be: Not running—0; Running—1; Interrupted—2; Failed—3; or Pass—4. The output from the test status register 270 may be wired directly to the external test controller 260.

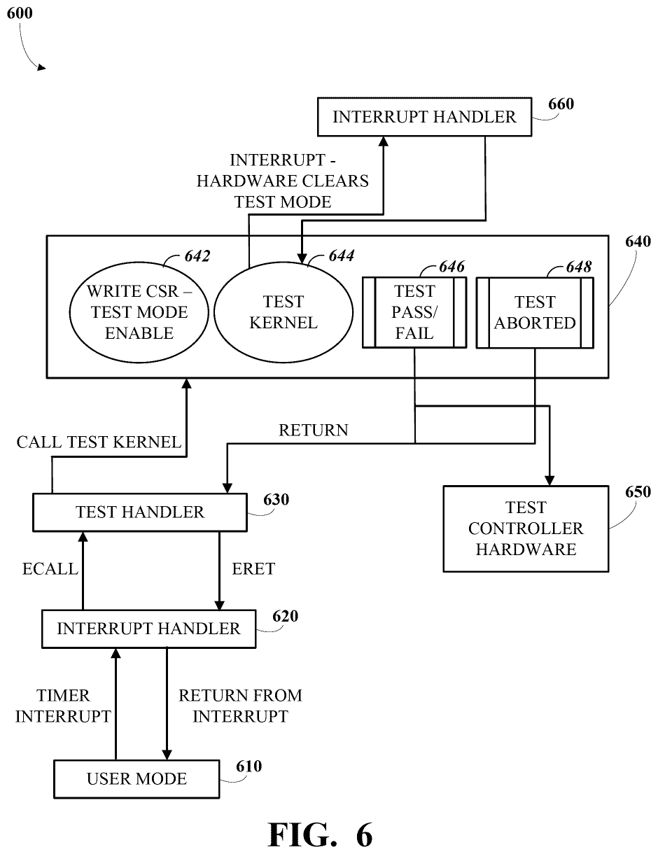

FIG. 3 is a flowchart of an example of a technique 300 for implementing a hardware test mode for a processor core. The technique 300 includes writing 310 to one or more test mode registers to change a microarchitectural state of a processor core from a first state to one or more test mode states; executing 320 a sequence of instructions on the processor core in the one or more test mode states to obtain a resulting architectural state of the processor core; comparing 330 the resulting architectural state to an expected architectural state associated with the sequence of instructions to obtain a test result; and writing 340 to the one or more test mode registers to restore the microarchitectural state of the processor core to the first state. The technique 300 may be used to implement efficient hardware testing of various components of the processor core during a field deployment. In some implementations, the technique 300 may be repeated periodically (e.g., every second, every 100 milliseconds, every 10 milliseconds, or every millisecond) to monitor the processor core to detect hardware fault conditions. For example, the technique 300 may be implemented using the integrated circuit 110 of FIG. 1. For example, the technique 300 may be implemented using the integrated circuit 210 of FIG. 2. For example, the technique 300 may be implemented using the software 600 of FIG. 6.

The technique 300 includes writing 310 to one or more test mode registers to change a microarchitectural state of a processor core (e.g., the processor core 120) from a first state to one or more test mode states. For example, the one or more test mode registers may include a control status register of the processor core. In some implementations, the one or more test mode registers are written to using a control status register instruction of an instruction set architecture supported by the processor core. In some implementations, the one or more test mode registers are memory mapped and are written to using a store instruction of an instruction set architecture supported by the processor core. For example, the one or more test mode registers may be written to by a test controller (e.g., the test controller 260) external to the processor core.

The technique 300 includes executing 320 a sequence of instructions (e.g., hardware test code) on the processor core in the one or more test mode states to obtain a resulting architectural state of the processor core. The one or more test mode states may cause particular components of the processor core to be used to execute instructions in the sequence of instructions to achieve broad coverage of the set of components of the processor core. In some implementations, at least one of the one or more test mode states forces a processor pipeline branch of the processor core to be selected in a dispatch stage of the processor core. In some implementations, at least one of the one or more test mode states causes a processor pipeline branch of the processor core to be disabled. In some implementations, at least one of the one or more test mode states forces a rename stage of the processor core to allocate physical registers of the processor core in a fixed order. In some implementations, at least one of the one or more test mode states forces each of multiple processor pipelines of the processor core to be selected in fixed order by a dispatch stage of the processor core. For example, the resulting architectural state of the processor core may include values written back to architectural registers of the processor core by instructions in the sequence of instructions when those instructions are retired. In some implementations, hardware test code stored in memory can be partitioned into test segments that may be executed in any order and any combination.

The technique 300 includes comparing 330 the resulting architectural state to an expected architectural state associated with the sequence of instructions to obtain a test result. The expected architectural state may be part of an expected result of executing the sequence of instructions. A deviation of the resulting architectural state from the expected architectural state may indicate a hardware fault has occurred in one or more components of the processor core. In some implementations, the resulting architectural state is compared 330 directly, bit-for-bit to the expected architectural state in order to detect potential errors. In some implementations, the resulting architectural state is compared 330 to the expected architectural state using a hash function that enables comparison of compressed forms of the resulting architectural state and the expected architectural state. For example, the system 500 of FIG. 5 may be used to generate a signature based on data including the resulting architectural state, and this signature may be compared 330 to an expected signature that is based on the expected architectural state in order to detect potential hardware error conditions.

The technique 300 includes writing 340 to the one or more test mode registers to restore the microarchitectural state of the processor core to the first state. Switching the microarchitectural state back to the first state may enable user application software to continue to run normally on the processor core after a hardware test using the one or more test mode states has been completed. Restoring the microarchitectural state after hardware testing the processor core may thus enable the hardware test to be performed on the processor core during a field deployment of a system including the processor core. In some implementations, the hardware test mode is interruptible to provide greater availability of the processor core for user application software. For example, when interrupts are supported during the hardware test mode, responding to such an interrupt may include writing to the one or more test mode registers to restore the microarchitectural state of the processor core to the first state; and, after completion of a handling routine for the interrupt and completion of execution of the sequence of instructions, checking the one or more test mode registers to determine whether the test mode has been interrupted. In some implementations, a hardware test result may be ignored when the one or more test mode registers indicate that the test that produced the hardware test result was interrupted. For example, the technique 400 of FIG. 4 may be implemented to respond to an interrupt occurring while a hardware test of the processor core is being performed.

FIG. 4 is a flowchart of an example of a technique 400 for handling an interrupt during a test executed in a hardware test mode. The technique 400 includes, responsive to an interrupt, writing 410 to the one or more test mode registers to restore the microarchitectural state of the processor core to the first state; and, after completion of a handling routine for the interrupt and completion of execution of the sequence of instructions, checking 420 the one or more test mode registers to determine whether the test mode has been interrupted. For example, the technique 400 may be implemented using the integrated circuit 110 of FIG. 1. For example, the technique 400 may be implemented using the integrated circuit 210 of FIG. 2. For example, the technique 400 may be implemented using the software 600 of FIG. 6.

The technique 400 includes, responsive to an interrupt, writing 410 to the one or more test mode registers to restore the microarchitectural state of the processor core to the first state. The microarchitectural state of the processor core may be restored to the first state to enable an interrupt handling routine associated with the interrupt to be executed by the processor core normally and efficiently even when the interrupt occurs while the processor core is executing a hardware test using the one or more test mode states. For example, the one or more test mode registers may be written 410 by an interrupt handling routine to restore the first state. For example, the one or more test mode registers may be written 410 by test mode circuitry of the processor core (e.g., test mode circuitry 150) in response to the interrupt.

The technique 400 includes, after completion of a handling routine for the interrupt and completion of execution of the sequence of instructions, checking 420 the one or more test mode registers to determine whether the test mode has been interrupted. Checking 420 the one or more test mode registers to determine whether the test mode has been interrupted may enable appropriate interpretation of result of hardware testing that is subject to the interrupt. For example, a hardware test result may be ignored when the one or more test mode registers indicate that the test that produced the hardware test result was interrupted.

FIG. 5 is a block diagram of an example of a system 500 for generating test result data based on data resulting from the execution of a sequence of instructions in a hardware test mode. The system 500 includes a core pipeline 510 that executes a sequence of instructions (e.g., hardware test code) in a hardware test mode controlled based on the values of one or more test mode registers. As the core pipeline 510 executes these instructions, information about the instructions 520, including opcodes for retiring instructions and associated data that a retiring instruction has written back to a physical register file of the processor core and/or data written to memory by a retiring instruction, is XORed 530 (exclusive or) with a signature 540 that summarizes results of a hardware test of processor core including the core pipeline 510. After the sequence of instructions has been retired, the resulting signature 540 may be compared to an expected signature value associated with the sequence of instructions that was executed in order to detect whether a hardware fault condition has occurred. For example, XORing the results for the instructions in the sequence of instructions may serve as a hash function for compressing test results into a format that can more easily be exported from the processor core and/or compared to corresponding expected test result.

In some implementations, the software performs accumulation using the XOR operation 530 and a bank of 7 (or more) registers, which are round robin allocated to keep the pipeline 510 from stalling on a single dependency. A new signature register 540 (e.g., 64-bit) may be added to the CSR (m-mode space). For example, the signature register 540 can be read and written to with CSR operations. When reading the signature register 540, the read value returned may exclude the signature of the CSR read operation itself, although it may be accumulated afterwards if test mode is enabled. When writing the signature register 540, the written value will be stored before accumulating the CSR write data itself, although it may be accumulated afterwards if test mode is enabled. The last read value on the signature register 540 may also be stored into an output register (e.g., the one or more test result registers 140), its value is wired directly out of the core and into an external test controller unit (e.g., the test controller 260).

When test mode is enabled, all retiring instructions opcodes and register write data may be accumulated into the signature register 540 using an XOR function 530 this may include: the instruction opcodes are accumulated (e.g., 16 or 32 bits); for ALU (FP and Integer) operations the destination register value is accumulated. For load operations the return data is accumulated, as it is a register write. In some implementations, for store operations, no data is accumulated, as no register is written. For CSR write operations, the CSR write data may be accumulated. For CSR read operations, the read data may be accumulated, as it is a register write.

The signature accumulation has certain challenges in some processor micro-architectures, such as where the processor core can retire multiple instructions (e.g., 6*7=42 instructions per cycle) and the write data isn't kept in the ROB (size) but written to the register file before retirement. Some ideas to make this more efficient include: storing the register write data into a new array, which is then read and accumulated when instructions retire; expected size may be the number of instructions in the pipeline×64 bits data+32 bits opcode. One way to save area here is to hash the data down into something smaller, e.g., combine in the opcode or even reduce the 64-bit data to 32 bits. Adding extra read ports to the physical register file (PRF) and then reading the write data back out when an instruction retires. In some implementations, the max retirement rate may be Reduced, which is likely to impact performance and hence coverage.

FIG. 6 is a block diagram of an example of software 600 for utilizing a hardware test mode for a processor core. The software 600 includes user mode software 610 (e.g., user application software); an interrupt handler 620; a test handler 630, hardware test code 640; and an interrupt handler 660 configured to handle interrupts occurring while a test using the one or more test modes is being performed using the processor core. The hardware test code 640 includes code 642 to write to a control status register (CSR) to enable a hardware test mode and a test kernel 644. For example, the hardware test code 640 may be executed using a machine mode (m-mode) privilege level on the processor core. The hardware test code 640 may produce a test result 646 indicating whether a hardware test passed or failed and a test aborted indication 648 that indicates whether the hardware test has been aborted or interrupted. The software 600 may interface with test controller hardware 650, which may coordinate hardware testing of processor cores on an integrated circuit (e.g., a system on a chip (SOC)) and/or the response to detect of hardware fault condition in one of the processor cores, such as reallocation of user application threads to run on other processor cores. In some implementations, the test controller hardware 650 may restart a test upon receiving a test aborted indication 648 indicating that the test has been aborted or interrupted.

The software 600 may be configured to enter a hardware test mode and then leave it again. It may be desirable to take an interrupt on top of test mode and have it leave the test mode as part of the interrupt. An example of such an operation may include making a system call (ecall) which puts you into machine mode (M-mode), and calls the test kernel 644. The test mode may be enabled by writing a CSR. In some implementations, multiple chicken bits may be written rather than a single master switch. The test may run, with whatever interrupts it wants enabled. In the event of an interrupt: test mode may be disabled by the hardware (e.g., by clearing a CSR bit). In some implementations, the software 600 disables test mode. For example, the interrupt and exception vectors may be configured to aware of what settings need to be adjusted, especially in the case of multiple chicken bits. On return from interrupt handler 660, the test mode may remain disabled. When test kernel 644 reaches the end of a test segment it will check if test mode is still enabled, if it is disabled then it will report the segment as aborted 648 and perhaps repeat it depending on the test logic. Before leaving the test kernel 644 it should disable test mode. In some implementations, the hardware test mode can only be enabled in m-mode. For example, leaving m-mode may also disable automatically the hardware test mode. The above would mean a new machine mode CSR which contains a ‘test mode enable’ flag, which can be written to and read with the CSR instructions.

A timer interrupt may be used during execution of user mode software 610 to trigger periodic hardware testing of a processor core. The timer interrupt may invoke the interrupt handler 620, which in turn calls the test handler 630. In some implementations, a timer interrupt triggering periodic hardware testing comes from an external controller.

### Exceptions:

As the test kernel 644 is trying to detect permanent faults within the core we have to assume the test kernel 644 may execute incorrectly if the core is faulty. Exceptions therefore could be of two types: 1. A fault in the core causes otherwise correct code to raise an exception; or 2. the test kernel 644 wishes to test the exception handling part of the core. For the first case, the exception should lead to a failure, it maybe the standard exception vector needs to check if test mode is enabled and if it is then disable it and report a fault to the test controller. For the second case, the test kernel 644 should be able to catch precise exceptions and accumulate their result into the final test result (e.g., illegal instruction).

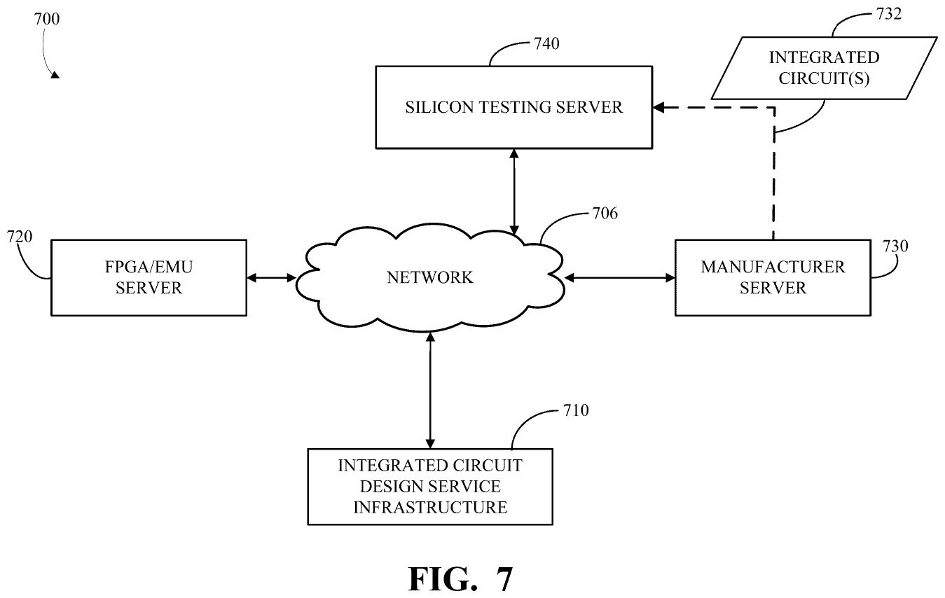

FIG. 7 is a block diagram of an example of a system 700 for generation and manufacture of integrated circuits. The system 700 includes a network 706, an integrated circuit design service infrastructure 710, a field programmable gate array (FPGA)/emulator server 720, and a manufacturer server 730. For example, a user may utilize a web client or a scripting API client to command the integrated circuit design service infrastructure 710 to automatically generate an integrated circuit design based a set of design parameter values selected by the user for one or more template integrated circuit designs. In some implementations, the integrated circuit design service infrastructure 710 may be configured to generate an integrated circuit design that includes the circuitry shown and described in FIG. 1.

The integrated circuit design service infrastructure 710 may include a register-transfer level (RTL) service module configured to generate an RTL data structure for the integrated circuit based on a design parameters data structure. For example, the RTL service module may be implemented as Scala code. For example, the RTL service module may be implemented using Chisel. For example, the RTL service module may be implemented using flexible intermediate representation for register-transfer level (FIRRTL) and/or a FIRRTL compiler. For example, the RTL service module may be implemented using Diplomacy. For example, the RTL service module may enable a well-designed chip to be automatically developed from a high-level set of configuration settings using a mix of Diplomacy, Chisel, and FIRRTL. The RTL service module may take the design parameters data structure (e.g., a java script object notation (JSON) file) as input and output an RTL data structure (e.g., a Verilog file) for the chip.

In some implementations, the integrated circuit design service infrastructure 710 may invoke (e.g., via network communications over the network 706) testing of the resulting design that is performed by the FPGA/emulation server 720 that is running one or more FPGAs or other types of hardware or software emulators. For example, the integrated circuit design service infrastructure 710 may invoke a test using a field programmable gate array, programmed based on a field programmable gate array emulation data structure, to obtain an emulation result. The field programmable gate array may be operating on the FPGA/emulation server 720, which may be a cloud server. Test results may be returned by the FPGA/emulation server 720 to the integrated circuit design service infrastructure 710 and relayed in a useful format to the user (e.g., via a web client or a scripting API client).

The integrated circuit design service infrastructure 710 may also facilitate the manufacture of integrated circuits using the integrated circuit design in a manufacturing facility associated with the manufacturer server 730. In some implementations, a physical design specification (e.g., a graphic data system (GDS) file, such as a GDS II file) based on a physical design data structure for the integrated circuit is transmitted to the manufacturer server 730 to invoke manufacturing of the integrated circuit (e.g., using manufacturing equipment of the associated manufacturer). For example, the manufacturer server 730 may host a foundry tape out website that is configured to receive physical design specifications (e.g., as a GDSII file or an OASIS file) to schedule or otherwise facilitate fabrication of integrated circuits. In some implementations, the integrated circuit design service infrastructure 710 supports multi-tenancy to allow multiple integrated circuit designs (e.g., from one or more users) to share fixed costs of manufacturing (e.g., reticle/mask generation, and/or shuttles wafer tests). For example, the integrated circuit design service infrastructure 710 may use a fixed package (e.g., a quasi-standardized packaging) that is defined to reduce fixed costs and facilitate sharing of reticle/mask, wafer test, and other fixed manufacturing costs. For example, the physical design specification may include one or more physical designs from one or more respective physical design data structures in order to facilitate multi-tenancy manufacturing.

In response to the transmission of the physical design specification, the manufacturer associated with the manufacturer server 730 may fabricate and/or test integrated circuits based on the integrated circuit design. For example, the associated manufacturer (e.g., a foundry) may perform optical proximity correction (OPC) and similar post-tapeout/pre-production processing, fabricate the integrated circuit(s) 732, update the integrated circuit design service infrastructure 710 (e.g., via communications with a controller or a web application server) periodically or asynchronously on the status of the manufacturing process, perform appropriate testing (e.g., wafer testing), and send to packaging house for packaging. A packaging house may receive the finished wafers or dice from the manufacturer and test materials and update the integrated circuit design service infrastructure 710 on the status of the packaging and delivery process periodically or asynchronously. In some implementations, status updates may be relayed to the user when the user checks in using the web interface and/or the controller might email the user that updates are available.

In some implementations, the resulting integrated circuits 732 (e.g., physical chips) are delivered (e.g., via mail) to a silicon testing service provider associated with a silicon testing server 740. In some implementations, the resulting integrated circuits 732 (e.g., physical chips) are installed in a system controlled by silicon testing server 740 (e.g., a cloud server) making them quickly accessible to be run and tested remotely using network communications to control the operation of the integrated circuits 732. For example, a login to the silicon testing server 740 controlling a manufactured integrated circuits 732 may be sent to the integrated circuit design service infrastructure 710 and relayed to a user (e.g., via a web client). For example, the integrated circuit design service infrastructure 710 may control testing of one or more integrated circuits 732, which may be structured based on an RTL data structure.

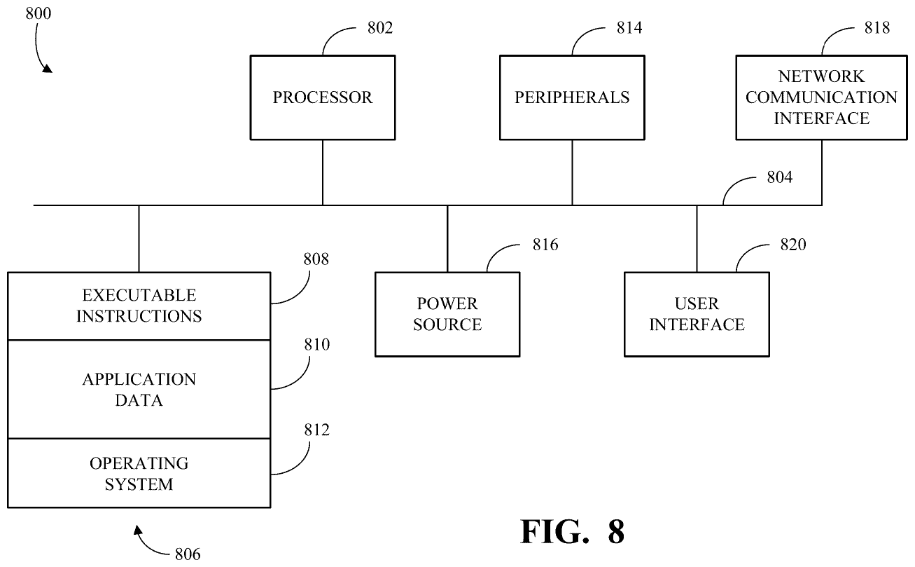

FIG. 8 is a block diagram of an example of a system 800 for facilitating generation of integrated circuits, for facilitating generation of a circuit representation for an integrated circuit, and/or for programming or manufacturing an integrated circuit. The system 800 is an example of an internal configuration of a computing device. The system 800 may be used to implement the integrated circuit design service infrastructure 710, and/or to generate a file that generates a circuit representation of an integrated circuit design including the circuitry shown and described in FIG. 1. The system 800 can include components or units, such as a processor 802, a bus 804, a memory 806, peripherals 814, a power source 816, a network communication interface 818, a user interface 820, other suitable components, or a combination thereof.

The processor 802 can be a central processing unit (CPU), such as a microprocessor, and can include single or multiple processors having single or multiple processing cores. Alternatively, the processor 802 can include another type of device, or multiple devices, now existing or hereafter developed, capable of manipulating or processing information. For example, the processor 802 can include multiple processors interconnected in any manner, including hardwired or networked, including wirelessly networked. In some implementations, the operations of the processor 802 can be distributed across multiple physical devices or units that can be coupled directly or across a local area or other suitable type of network. In some implementations, the processor 802 can include a cache, or cache memory, for local storage of operating data or instructions.

The memory 806 can include volatile memory, non-volatile memory, or a combination thereof. For example, the memory 806 can include volatile memory, such as one or more DRAM modules such as double data rate (DDR) synchronous dynamic random access memory (SDRAM), and non-volatile memory, such as a disk drive, a solid state drive, flash memory, Phase-Change Memory (PCM), or any form of non-volatile memory capable of persistent electronic information storage, such as in the absence of an active power supply. The memory 806 can include another type of device, or multiple devices, now existing or hereafter developed, capable of storing data or instructions for processing by the processor 802. The processor 802 can access or manipulate data in the memory 806 via the bus 804. Although shown as a single block in FIG. 8, the memory 806 can be implemented as multiple units. For example, a system 800 can include volatile memory, such as RAM, and persistent memory, such as a hard drive or other storage.

The memory 806 can include executable instructions 808, data, such as application data 810, an operating system 812, or a combination thereof, for immediate access by the processor 802. The executable instructions 808 can include, for example, one or more application programs, which can be loaded or copied, in whole or in part, from non-volatile memory to volatile memory to be executed by the processor 802. The executable instructions 808 can be organized into programmable modules or algorithms, functional programs, codes, code segments, or combinations thereof to perform various functions described herein. For example, the executable instructions 808 can include instructions executable by the processor 802 to cause the system 800 to automatically, in response to a command, generate an integrated circuit design and associated test results based on a design parameters data structure. The application data 810 can include, for example, user files, database catalogs or dictionaries, configuration information or functional programs, such as a web browser, a web server, a database server, or a combination thereof. The operating system 812 can be, for example, Microsoft Windows®, macOS®, or Linux®; an operating system for a small device, such as a smartphone or tablet device; or an operating system for a large device, such as a mainframe computer. The memory 806 can comprise one or more devices and can utilize one or more types of storage, such as solid state or magnetic storage.

The peripherals 814 can be coupled to the processor 802 via the bus 804. The peripherals 814 can be sensors or detectors, or devices containing any number of sensors or detectors, which can monitor the system 800 itself or the environment around the system 800. For example, a system 800 can contain a temperature sensor for measuring temperatures of components of the system 800, such as the processor 802. Other sensors or detectors can be used with the system 800, as can be contemplated. In some implementations, the power source 816 can be a battery, and the system 800 can operate independently of an external power distribution system. Any of the components of the system 800, such as the peripherals 814 or the power source 816, can communicate with the processor 802 via the bus 804.

The network communication interface 818 can also be coupled to the processor 802 via the bus 804. In some implementations, the network communication interface 818 can comprise one or more transceivers. The network communication interface 818 can, for example, provide a connection or link to a network, such as the network 706 shown in FIG. 7, via a network interface, which can be a wired network interface, such as Ethernet, or a wireless network interface. For example, the system 800 can communicate with other devices via the network communication interface 818 and the network interface using one or more network protocols, such as Ethernet, transmission control protocol (TCP), Internet protocol (IP), power line communication (PLC), wireless fidelity (Wi-Fi), infrared, general packet radio service (GPRS), global system for mobile communications (GSM), code division multiple access (CDMA), or other suitable protocols.

A user interface 820 can include a display; a positional input device, such as a mouse, touchpad, touchscreen, or the like; a keyboard; or other suitable human or machine interface devices. The user interface 820 can be coupled to the processor 802 via the bus 804. Other interface devices that permit a user to program or otherwise use the system 800 can be provided in addition to or as an alternative to a display. In some implementations, the user interface 820 can include a display, which can be a liquid crystal display (LCD), a cathode-ray tube (CRT), a light emitting diode (LED) display (e.g., an organic light emitting diode (OLED) display), or other suitable display. In some implementations, a client or server can omit the peripherals 814. The operations of the processor 802 can be distributed across multiple clients or servers, which can be coupled directly or across a local area or other suitable type of network. The memory 806 can be distributed across multiple clients or servers, such as network-based memory or memory in multiple clients or servers performing the operations of clients or servers. Although depicted here as a single bus, the bus 804 can be composed of multiple buses, which can be connected to one another through various bridges, controllers, or adapters.

A non-transitory computer readable medium may store a circuit representation that, when processed by a computer, is used to program or manufacture an integrated circuit. For example, the circuit representation may describe the integrated circuit specified using a computer readable syntax. The computer readable syntax may specify the structure or function of the integrated circuit or a combination thereof. In some implementations, the circuit representation may take the form of a hardware description language (HDL) program, a register-transfer level (RTL) data structure, a flexible intermediate representation for register-transfer level (FIRRTL) data structure, a Graphic Design System II (GDSII) data structure, a netlist, or a combination thereof. In some implementations, the integrated circuit may take the form of a field programmable gate array (FPGA), application specific integrated circuit (ASIC), system-on-a-chip (SoC), or some combination thereof. A computer may process the circuit representation in order to program or manufacture an integrated circuit, which may include programming a field programmable gate array (FPGA) or manufacturing an application specific integrated circuit (ASIC) or a system on a chip (SoC). In some implementations, the circuit representation may comprise a file that, when processed by a computer, may generate a new description of the integrated circuit. For example, the circuit representation could be written in a language such as Chisel, an HDL embedded in Scala, a statically typed general purpose programming language that supports both object-oriented programming and functional programming.

In an example, a circuit representation may be a Chisel language program which may be executed by the computer to produce a circuit representation expressed in a FIRRTL data structure. In some implementations, a design flow of processing steps may be utilized to process the circuit representation into one or more intermediate circuit representations followed by a final circuit representation which is then used to program or manufacture an integrated circuit. In one example, a circuit representation in the form of a Chisel program may be stored on a non-transitory computer readable medium and may be processed by a computer to produce a FIRRTL circuit representation. The FIRRTL circuit representation may be processed by a computer to produce an RTL circuit representation. The RTL circuit representation may be processed by the computer to produce a netlist circuit representation. The netlist circuit representation may be processed by the computer to produce a GDSII circuit representation. The GDSII circuit representation may be processed by the computer to produce the integrated circuit.

In another example, a circuit representation in the form of Verilog or VHDL may be stored on a non-transitory computer readable medium and may be processed by a computer to produce an RTL circuit representation. The RTL circuit representation may be processed by the computer to produce a netlist circuit representation. The netlist circuit representation may be processed by the computer to produce a GDSII circuit representation. The GDSII circuit representation may be processed by the computer to produce the integrated circuit. The foregoing steps may be executed by the same computer, different computers, or some combination thereof, depending on the implementation.

In a first aspect, the subject matter described in this specification can be embodied in an integrated circuit that includes a processor core configured to execute instructions; one or more test mode registers configured to store test mode selection data; one or more test result registers configured to store test result data; and a test mode circuitry configured to: change a microarchitectural state of the processor core from a first state to one or more test mode states based on test mode selection data written to the one or more test mode registers; execute a sequence of instructions on the processor core in the one or more test mode states to obtain a resulting architectural state of the processor core; store test result data based on the resulting architectural state in the one or more test result registers; and after executing the sequence of instructions, restore the microarchitectural state of the processor core to the first state based on test mode selection data written to the one or more test mode registers.

In the first aspect, at least one of the one or more test mode states may force a processor pipeline of the processor core to be selected in a dispatch stage of the processor core. In the first aspect, at least one of the one or more test mode states may cause a processor pipeline of the processor core to be disabled. In the first aspect, at least one of the one or more test mode states may force a rename stage of the processor core to allocate physical registers of the processor core in a fixed order. In the first aspect, at least one of the one or more test mode states may force each of multiple processor pipelines of the processor core to be selected in fixed order by a dispatch stage of the processor core. In the first aspect, the test result data may include an XOR of data, including the resulting architectural state, generated when executing the sequence of instructions. In the first aspect, the test result data may include an XOR of data, including opcodes for retired instructions, generated when executing the sequence of instructions. In the first aspect, the test result data may be based on intermediate results generated when executing an instruction of the sequence of instructions before the instruction is retired. In the first aspect, the test mode circuitry may be configured to, responsive to an interrupt, write to the one or more test mode registers to restore the microarchitectural state of the processor core to the first state; and, after completion of a handling routine for the interrupt and completion of execution of the sequence of instructions, check the one or more test mode registers to determine whether the test mode has been interrupted.

In a second aspect, the subject matter described in this specification can be embodied in methods that include writing to one or more test mode registers to change a microarchitectural state of a processor core from a first state to one or more test mode states; executing a sequence of instructions on the processor core in the one or more test mode states to obtain a resulting architectural state of the processor core; comparing the resulting architectural state to an expected architectural state associated with the sequence of instructions to obtain a test result; and writing to the one or more test mode registers to restore the microarchitectural state of the processor core to the first state.

In the second aspect, at least one of the one or more test mode states may force a processor pipeline of the processor core to be selected in a dispatch stage of the processor core. In the second aspect, at least one of the one or more test mode states may cause a processor pipeline of the processor core to be disabled. In the second aspect, at least one of the one or more test mode states may force a rename stage of the processor core to allocate physical registers of the processor core in a fixed order. In the second aspect, at least one of the one or more test mode states may force each of multiple processor pipelines of the processor core to be selected in fixed order by a dispatch stage of the processor core. In the second aspect, the methods may include, responsive to an interrupt, writing to the one or more test mode registers to restore the microarchitectural state of the processor core to the first state; and, after completion of a handling routine for the interrupt and completion of execution of the sequence of instructions, checking the one or more test mode registers to determine whether the test mode has been interrupted. In the second aspect, the one or more test mode registers may include a control status register of the processor core. In the second aspect, the one or more test mode registers may be written to using a control status register instruction of an instruction set architecture supported by the processor core. In the second aspect, the one or more test mode registers may be memory mapped and may be written to using a store instruction of an instruction set architecture supported by the processor core.

In a third aspect, the subject matter described in this specification can be embodied in a non-transitory computer readable medium comprising a circuit representation that, when processed by a computer, is used to program or manufacture an integrated circuit that includes a processor core configured to execute instructions; one or more test mode registers configured to store test mode selection data; one or more test result registers configured to store test result data; and a test mode circuitry configured to: change a microarchitectural state of the processor core from a first state to one or more test mode states based on test mode selection data written to the one or more test mode registers; execute a sequence of instructions on the processor core in the one or more test mode states to obtain a resulting architectural state of the processor core; store test result data based on the resulting architectural state in the one or more test result registers; and, after executing the sequence of instructions, restore the microarchitectural state of the processor core to the first state based on test mode selection data written to the one or more test mode registers.

In the third aspect, at least one of the one or more test mode states may force a processor pipeline of the processor core to be selected in a dispatch stage of the processor core. In the third aspect, at least one of the one or more test mode states may cause a processor pipeline of the processor core to be disabled. In the third aspect, at least one of the one or more test mode states may force a rename stage of the processor core to allocate physical registers of the processor core in a fixed order. In the third aspect, at least one of the one or more test mode states may force each of multiple processor pipelines of the processor core to be selected in fixed order by a dispatch stage of the processor core. In the third aspect, the test result data may include an XOR of data, including the resulting architectural state, generated when executing the sequence of instructions. In the third aspect, the test result data may include an XOR of data, including opcodes for retired instructions, generated when executing the sequence of instructions. In the third aspect, the test result data may be based on intermediate results generated when executing an instruction of the sequence of instructions before the instruction is retired. In the third aspect, the test mode circuitry may be configured to: responsive to an interrupt, write to the one or more test mode registers to restore the microarchitectural state of the processor core to the first state; and, after completion of a handling routine for the interrupt and completion of execution of the sequence of instructions, check the one or more test mode registers to determine whether the test mode has been interrupted. In the third aspect, the integrated circuit may include: a test controller, external to the processor core, configured to periodically initiate testing of the processor core by writing to the one or more test mode registers; a test status register accessible by the test controller; and the test mode circuitry is configured to: write a test identifier to the test status register; and write an indication of test status to the test status register, wherein the indication of test status indicates whether a test is running, interrupted, or completed.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An integrated circuit comprising:
a processor core configured to execute instructions;
one or more test mode registers configured to store test mode selection data;
one or more test result registers configured to store test result data; and
a test mode circuitry configured to:
change a microarchitectural state of the processor core from a first state to one or more test mode states based on test mode selection data written to the one or more test mode registers;
execute a sequence of instructions on the processor core in the one or more test mode states to obtain a resulting architectural state of the processor core;
store test result data based on the resulting architectural state in the one or more test result registers; and
after executing the sequence of instructions, restore the microarchitectural state of the processor core to the first state based on test mode selection data written to the one or more test mode registers.

2. The integrated circuit of claim 1, in which at least one of the one or more test mode states forces a processor pipeline branch of the processor core to be selected in a dispatch stage of the processor core.

3. The integrated circuit of claim 1, in which at least one of the one or more test mode states causes a processor pipeline branch of the processor core to be disabled.

4. The integrated circuit of claim 1, in which at least one of the one or more test mode states forces a rename stage of the processor core to allocate physical registers of the processor core in a fixed order.

5. The integrated circuit of claim 1, in which at least one of the one or more test mode states forces each of multiple processor pipelines of the processor core to be selected in fixed order by a dispatch stage of the processor core.

6. The integrated circuit of claim 1, in which the test result data includes an XOR of data, including the resulting architectural state, generated when executing the sequence of instructions.

7. The integrated circuit of claim 1, in which the test result data includes an XOR of data, including opcodes for retired instructions, generated when executing the sequence of instructions.

8. The integrated circuit of claim 1, in which the test result data is based on intermediate results generated when executing an instruction of the sequence of instructions before the instruction is retired.

9. The integrated circuit of claim 1, in which the test mode circuitry is configured to:
responsive to an interrupt, write to the one or more test mode registers to restore the microarchitectural state of the processor core to the first state; and
after completion of a handling routine for the interrupt and completion of execution of the sequence of instructions, check the one or more test mode registers to determine whether the test mode has been interrupted.

10. The integrated circuit of claim 1, comprising:
a test controller, external to the processor core, configured to periodically initiate testing of the processor core by writing to the one or more test mode registers;
a test status register accessible by the test controller; and
the test mode circuitry is configured to:
write a test identifier to the test status register; and
write an indication of test status to the test status register, wherein the indication of test status indicates whether a test is running, interrupted, or completed.

11. A method, comprising:
writing to one or more test mode registers to change a microarchitectural state of a processor core from a first state to one or more test mode states;
executing a sequence of instructions on the processor core in the one or more test mode states to obtain a resulting architectural state of the processor core;
comparing the resulting architectural state to an expected architectural state associated with the sequence of instructions to obtain a test result; and
writing to the one or more test mode registers to restore the microarchitectural state of the processor core to the first state.

12. The method of claim 11, in which at least one of the one or more test mode states forces a processor pipeline branch of the processor core to be selected in a dispatch stage of the processor core.

13. The method of claim 11, in which at least one of the one or more test mode states causes a processor pipeline branch of the processor core to be disabled.

14. The method of claim 11, in which at least one of the one or more test mode states forces a rename stage of the processor core to allocate physical registers of the processor core in a fixed order.

15. The method of claim 11, in which at least one of the one or more test mode states forces each of multiple processor pipelines of the processor core to be selected in fixed order by a dispatch stage of the processor core.

16. The method of claim 11, comprising:
responsive to an interrupt, writing to the one or more test mode registers to restore the microarchitectural state of the processor core to the first state; and
after completion of a handling routine for the interrupt and completion of execution of the sequence of instructions, checking the one or more test mode registers to determine whether the test mode has been interrupted.

17. The method of claim 11, in which the one or more test mode registers include a control status register of the processor core.

18. The method of claim 11, in which the one or more test mode registers are written to using a control status register instruction of an instruction set architecture supported by the processor core.

19. The method of claim 11, in which the one or more test mode registers are memory mapped and are written to using a store instruction of an instruction set architecture supported by the processor core.

20. A non-transitory computer readable medium comprising a circuit representation that, when processed by a computer, is used to program or manufacture an integrated circuit comprising:
a processor core configured to execute instructions;
one or more test mode registers configured to store test mode selection data;
one or more test result registers configured to store test result data; and
a test mode circuitry configured to:
change a microarchitectural state of the processor core from a first state to one or more test mode states based on test mode selection data written to the one or more test mode registers;
execute a sequence of instructions on the processor core in the one or more test mode states to obtain a resulting architectural state of the processor core;
store test result data based on the resulting architectural state in the one or more test result registers; and
after executing the sequence of instructions, restore the microarchitectural state of the processor core to the first state based on test mode selection data written to the one or more test mode registers.
